(19) United States
(12) Patent Application Publication
(10) Pub. No.: US 2010/0019967 A1
(43) Pub. Date: Jan. 28, 2010

(54) Method and apparatus for determining location

(76) Inventors: Farrokh Farrokhi, San Ramon, CA (US); Dickson Wong, Burlingame, CA (US); Arthur J. Collmeyer, Incline Village, NV (US)

Correspondence Address: Dickson Wong, 811 Guinda St, Palo Alto, CA, 94301, US

(21) Appl. No.: 12/220,612

(22) Filed: Jul. 25, 2008

(51) Int. Cl. G01S 1/00; G01S 5/14

(52) U.S. Cl. 342/357.09; 342/357.13

(57) ABSTRACT

A method and apparatus for determining location parameters by processing time and location datagrams made up of data contained in satellite positioning signals. In one embodiment, time and location datagrams are transferred to a GPS processing facility. In one embodiment, a plurality of time and location datagrams are combined. In one embodiment, time and location datagram size is increased, resulting in greater processing gains. In one embodiment, low frequency data overlay data is removed from the time and location datagrams.

### STATEMENT REGARDING FEDERALLY SPONSORED RESEARCH OR DEVELOPMENT

Not Applicable

### BACKGROUND OF THE INVENTION

This invention relates to the determination of location parameters of one or more GPS receivers.

Global positioning systems (GPS) utilize earth-orbiting satellites to transmit GPS signals which contain the necessary information for the determination of location and time coordinates of a GPS receiver. The NAVSTAR system, which has been operational since the early 1990's, as well as other systems currently being deployed operate on the same basic operation premise; utilize the time delay of signals transmitted by the satellites to the GPS receiver to determine the distance between multiple satellites and the GPS receiver at a precise moment in time.

The GPS signals from all the satellites are broadcast at the same carrier frequency. However, each satellite has a unique identifier, or pseudorandom noise (PRN) code having 1023 bits or chips, thereby enabling a GPS receiver to distinguish the GPS signal from one GPS satellite from the GPS signal from another GPS Satellite. At any one time, barring obstructions, a GPS receiver will have a direct view of multiple GPS satellites, otherwise known as the satellite constellation. Any obstruction such as buildings and mountains will degrade the incoming satellite signals and impact both sensitivity and accuracy performance.

A prior art GPS receiver 120 is illustrated in FIG. 1, where the incoming GPS signals 122 from the GPS satellite constellation 128 is received by the antenna 121. The received signal is input into the analog front end module 123. The main purpose of analog front end module 123 is to remove the 1.57 Ghz carrier frequency of the received signal. The down-converted signal, known as I/F signal 124, is input to the GPS processor 125.

FIG. 2 describes the data structure of the signal that is broadcast by each GPS satellite, where the signal contains a 50 Hz low frequency data overlay signal (low frequency data overlay); 20 mSec data bits modulated by a one millisecond PRN code having 1023 bits or chips. The PRN code is known as a spreading code because it spreads the frequency spectrum of the GPS signal. This spread spectrum signal is known as a direct sequence spread spectrum (DSSS) signal.

GPS processor 125 determines a one-way range, called a pseudorange because it includes a local time offset, to each GPS satellite from the time-of-arrival of the PRN code, the Zcount and ephemeris parameters in the GPS signal that it receives from that GPS satellite. Normally four or more pseudoranges are used for determining or overdetermining a three dimensional position and GPS time. Once pseudorange output 126 has been determined for at least four GPS satellites, it is a relatively simple process to determine the three dimensional location coordinates via triangulation as well as adding mapping and other application layer functions.

GPS processor 125 acquires signal power with a search algorithm. In a typical search algorithm, the local frequency is set to a first trial frequency and then correlations are determined between the incoming GPS signal PRN code and all possible code phases of a local replica of the code. In order ensure that the correct code phase is not missed, it is conventional to increment the replica code phase in one-half chip or even smaller steps. A high correlation value indicates that signal power has been found. If no correlations are high enough, the local frequency is set to a second trial frequency and the correlations are repeated. Although no one correlation will take a great deal of time, the great number of correlations that must be performed can result in the time to find signal power to acquire a GPS signal being the largest single component of the time to first fix (TTFF). The search algorithm is used to examine the down converted I/F signal as it streams in from the satellite constellation 128. The GPS processor 125 uses a sliding window approach for the search, therefore using a relatively small of amount of incoming I/F signal 124 at any one time.

The time for a GPS receiver to acquire the first location fix is known as the time to first fix (TTFF), generally includes (i) the time to acquire GPS signal power by tuning a local frequency and a local PRN replica code phase in the GPS receiver to match the carrier frequency and the PRN code phase of the incoming GPS signal, (ii) the time to receive data bits in the GPS signal to determine a GPS clock time, (iii) the time to receive ephemeris parameters in the GPS data bits, and (iv) the time to process the code phase timing, GPS clock time and ephemeris for determining a position.

In order to improve cold start sensitivity and TTFF, many GPS receivers are equipped to receive assistance from an external source. One well known technique is providing timing information to the GPS receiver from an external source via a communication link such as a cellular based data network. The timing information is used to set the initial frequency of the GPS receiver. This is commonly referred to as assisted GPS, or A-GPS. Aside from receiving timing information from an external source, the GPS signal processing functions of conventional GPS and A-GPS receivers are identical. Once again referring to FIG. 1, a GPS assistance device 129 has a clear view of satellite constellation 128 and determines the timing information via a communication link, it provides GPS processor 125 with the timing information 130 useful to setting the local oscillator frequency. Other assistance that the GPS receiver may receive from an external source may include constellation and almanac information, mapping, and wide area augmentation (WAAS) assistance.

However, the GPS processing techniques common to both GPS and A-GPS receivers are unable to provide reliable indoor-outdoor sensitivity and accuracy. Furthermore emerging location-based applications, such as E-911, mobile Yellow pages, and asset management require reliable indoor and outdoor operation.

There is a need in the art for a method of processing received C;PS signals that provides reliable operation at indoor and urban canyon locations.

### SUMMARY OF INVENTION

In general, the object of the present invention is to increase the receive sensitivity and accuracy of GPS receivers in order to provide for the reliable determination of location parameters, thus providing improved outdoor and indoor/urban canyon operation. GPS-based location devices have become the de facto standard for navigation assistance.

The fact that these devices are unreliable indoors is, for the most part, irrelevant. Emerging location-based applications, such as E-911, mobile Yellow pages, and asset management, on the other hand, require reliable indoor and outdoor operation. However, the GPS processing techniques employed in today's GPS devices are unable to provide the reliable indoor-outdoor sensitivity and accuracy that is required. Even with the improvements of A-GPS, it has been shown that GPS-only based clients cannot meet the acquisition reliability and accuracy required by emerging indoor applications.

It is a common belief that for most indoor and urban canyon environments, the received GPS satellite signals are too weak to reliably acquire a fix and What accuracy suffers by signal multi-path. However, there are a number of factors that limit the effectiveness of processing the received GPS signals. According to the present invention, there are advances in system architecture and signal processing methods that would extend GPS reliability and accuracy beyond prior art performance.

First, prior art GPS receivers do not take full advantage in the highly repetitive nature of incoming satellite signals. As mentioned above, prior art GPS receivers perform a search of the incoming I/F signal looking for peaks in the power caused by correlation of a specific PRN code. Furthermore, as described by FIG. 2, the data structure of the signal that is broadcast by each GPS satellite contains a low frequency data overlay; 20 mSec data bits modulated by a one millisecond PRN code having 1023 bits or chips. Due to the low frequency overlay, there is a bit boundary that occurs after twenty PRN code cycles. Therefore prior art GPS search techniques use very small number of PRN code cycles to obtain a correlation with a particular PRN code sequence; typically 10 PRN cycles.

Secondly, prior art GPS receivers do not take advantage of other GPS receivers within close proximity to each other. As with A-GPS, an A-GPS receiver will be provided assistance with timing information from an external source, but the processing of the incoming I/F signal is not enhanced by the combination processing of received signals from multiple GPS receivers that are in view of the same satellite constellation.

Instead of searching the received GPS signals as a stream of data using a sliding window approach as described above, one key that allows the current invention to remove these shortcomings is that incoming GPS data is placed in time and location specific datagrams of varying lengths by the GPS receiver. This is not a dissimilar concept of data packets used in data networking technologies. This allows the time and location datagrams to be post processed, allowing for a number of distinct advantages.

In one embodiment of the current invention, the low frequency data overlay embedded in transmitted satellite signal, as described by FIG. 2, is removed from the data contained in the time and location datagram. This results in a contiguous string of repetitive PRN code cycles that can be significantly larger than 20 PRN cycles. This allows for a processing gain that results in a much greater receive sensitivity characteristic.

In one embodiment of the current invention, a GPS signal processor processes two or more time and location datagrams using signal combining techniques, resulting in a much greater receive sensitivity characteristic. Furthermore, the combining effect will also aid in the resolution of multi-path. This allows for improved accuracy of location parameters for each individual GPS receiver. The greatest improvement results are achieved when the GPS signal processor 200 combines time and location specific datagrams from GPS receivers in view of the same satellite constellation at the same time.

In one embodiment of the current invention, the GPS signal processor aligns the timing of multiple datagrams in order to insure maximum signal combining effect.

In one embodiment of the current invention, the GPS signal processor aligns multiple datagrams of varying sizes.

In one embodiment of the current invention, the low frequency data overlay is removed from two or more time and location datagrams and are processed using signal combining resulting in improved sensitivity of the-satellite receivers.

In one embodiment of the current invention, input from a wide area augmentation system (WAAS) is used by the GPS processing facility to improve the location accuracy of all GPS receivers.

In one embodiment of the current invention, the time and location datagrams are transferred to the GPS processing facility via a wireless communication link. Examples include Wifi, 3G, GSM Edge, GPRS-Edge, Zigbee, and Bluetooth.

In one embodiment of the current invention, the time and location datagrams are transferred to the GPS processing facility via a wired communication link. Examples include Ethernet.

In one embodiment of the current invention, the time and location datagrams are transferred to the GPS processing facility via memory download.

### BRIEF DESCRIPTION OF DRAWINGS

FIG. 1 shows the system diagram of a prior art GPS receiver

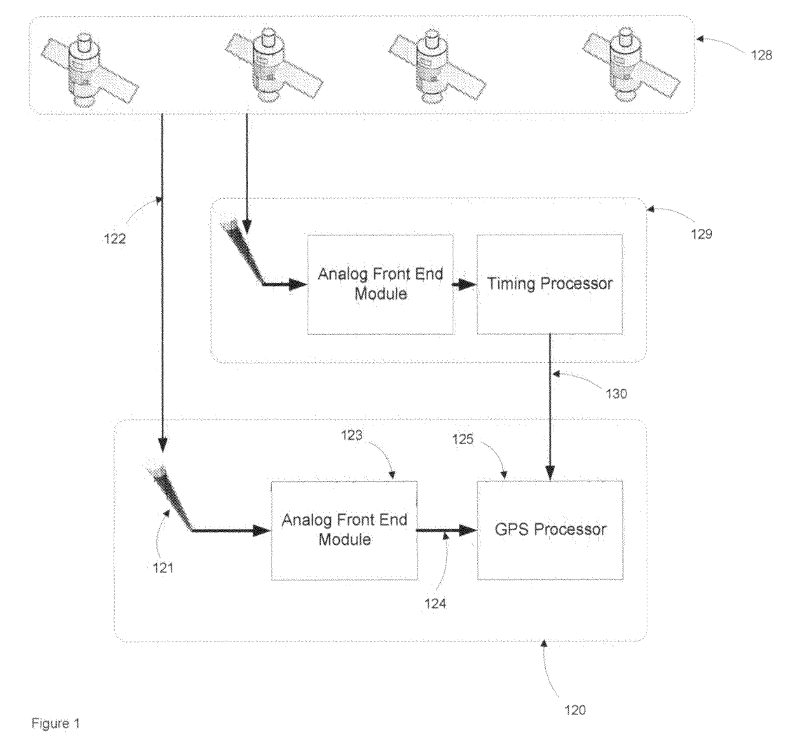

FIG. 2 describes the data structure transmitted by a GPS satellite

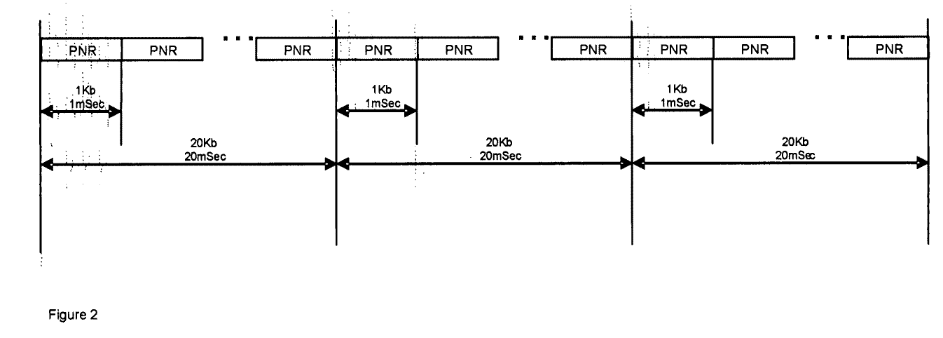

FIG. 3 shows the system diagram of the current invention

FIG. 4 describes the resulting data structure of the current invention

FIG. 5 shows the system diagram of the current invention

### DETAILED DESCRIPTION

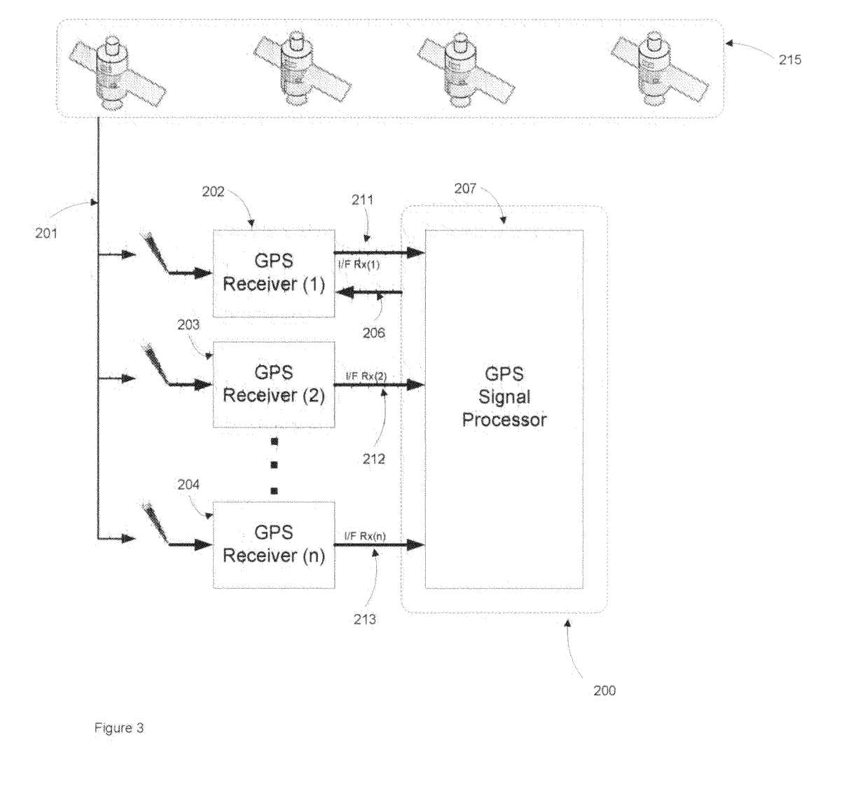

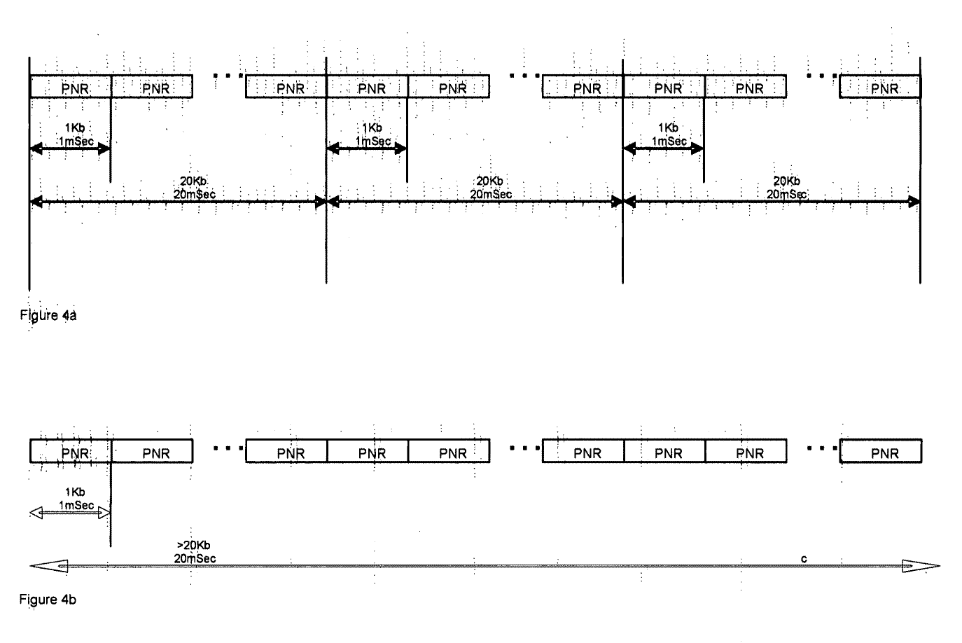

FIG. 3 shows a non-limiting embodiment of the current invention. Incoming GPS satellite signal 201 composed of transmitted signals from GPS satellite constellation 215 is received by a plurality of GPS receivers 202, 203, 204. Each GPS receiver contains an analog front end module (FEM) with primary responsibility to down convert the 1.57 GHz incoming GPS satellite signal 201. Each GPS receiver 202, 203, 204 forwards time and location datagrams, which contains the I/F data of the satellite constellation 215, to GPS processing facility 200. The time and location datagrams can be transferred to the GPS processing facility 200 via communication links 211, 212, 213 in real-time via a wireless or wired data communications link, or be stored in memory by the GPS receivers 202, 203, 204 and transferred to the GPS processing facility 200 at a later time. The time and location datagrams are processed by GPS signal processor 207. The GPS signal processor 207 removes the low frequency data overlay. Removing the low frequency data overlay results in a contiguous string of repetitive PRN code cycles that can be significantly larger 20 PRN code cycles. The increased data sire provides for increased processing gain, resulting in improved GPS receiver sensitivity. FIGS. 4a and 4b illustrate the resulting data structure of the incoming satellites signals resulting from the removal of the low frequency data overlay, where 4a describes the unprocessed satellite signals, and FIG. 4b described post processed data. The removal of the low frequency data overlay is performed on incoming time and location datagrams for each GPS receiver 202, 203, 204. GPS signal processor 207 determines the pseudorange for each GPS receiver 202, 203, 204 respectively. Once pseudorange information has been determined for at least four GPS satellites for each GPS receiver, it is a relatively simple process to determine the three dimensional location coordinates via triangulation as well as adding mapping and other application layer functions.

It is important to note that other GPS systems currently being deployed will have a similar low data rate overlay used in the NAVSTAR system. It is the object of the current invention that time and location datagrams from these alternate GPS systems be processed in a similar manner as to take advantage of the highly repetitive nature of GPS data.

FIG. 3 describes a second non-limiting embodiment of the current invention. Incoming GPS satellite signal 201 composed of transmitted signals from GPS satellite constellation 215 is received by a plurality of GPS receivers 20w, 203, 204. Each GPS receiver contains an analog front end module (FEM) with primary responsibility to down convert the 1.57 GHz incoming GPS satellite signal 201. Each GPS receiver 202, 203, 204 forwards time and location datagrams, which contains I/F data of the satellite constellation 215, to GPS processing facility 200. The time and location datagrams can be transferred to the GPS processing facility 200 via communication links 211, 212, 213 in real-time via a wireless or wired data communications link, or be stored in memory by the GPS receivers 202, 203, 204 and later transferred to the GPS facility 200 at a later time. Using two or more time and location datagrams, GPS signal processor 207 uses signal combining techniques, resulting in improved sensitivity and accuracy of each individual GPS receiver 202, 203, 204. GPS receivers in different locations, but in view of the same satellite constellation, contain significantly similar PNR code profiles, differing only by the time-of-arrival offset due to the location difference. Signal combining of two or more time and location datagrams increases the signal to noise ratio of each individual signal. Furthermore, GPS signal processor 207 can use time and location datagrams which have had the low frequency data overlay removed. This further increases the processing gain and results in even greater receive sensitivity and accuracy. GPS signal processor 207 determines the pseudorange for each GPS receiver 202, 203, 204. Once the pseudorange information has been determined for at least four GPS satellites per GPS receiver 202, 203, 204, it is a relatively simple process to determine the three dimensional location coordinates via triangulation as well as adding mapping and other application layer functions.

Furthermore, GPS signal processor 207 is capable of time aligning two or more time and location datagrams.

Furthermore, GPS signal processor 207 can use signal combining techniques using two or more time and location datagrams varying in size.

FIG. 3 describes yet another non-limiting embodiment of the current invention where GPS receivers receive external requests to obtain and/or forward time and location datagrams to a GPS processing facility. Non limiting examples include a request from an end user of an application seeking location coordinates of a particular GPS receiver. It could be a predetermined request by a GPS processing facility or location based application. This feature can be especially useful to extend battery life in GPS clients used in such applications as asset management tags. The ability to send a request to a particular GPS receiver is represented by location request signal 206.

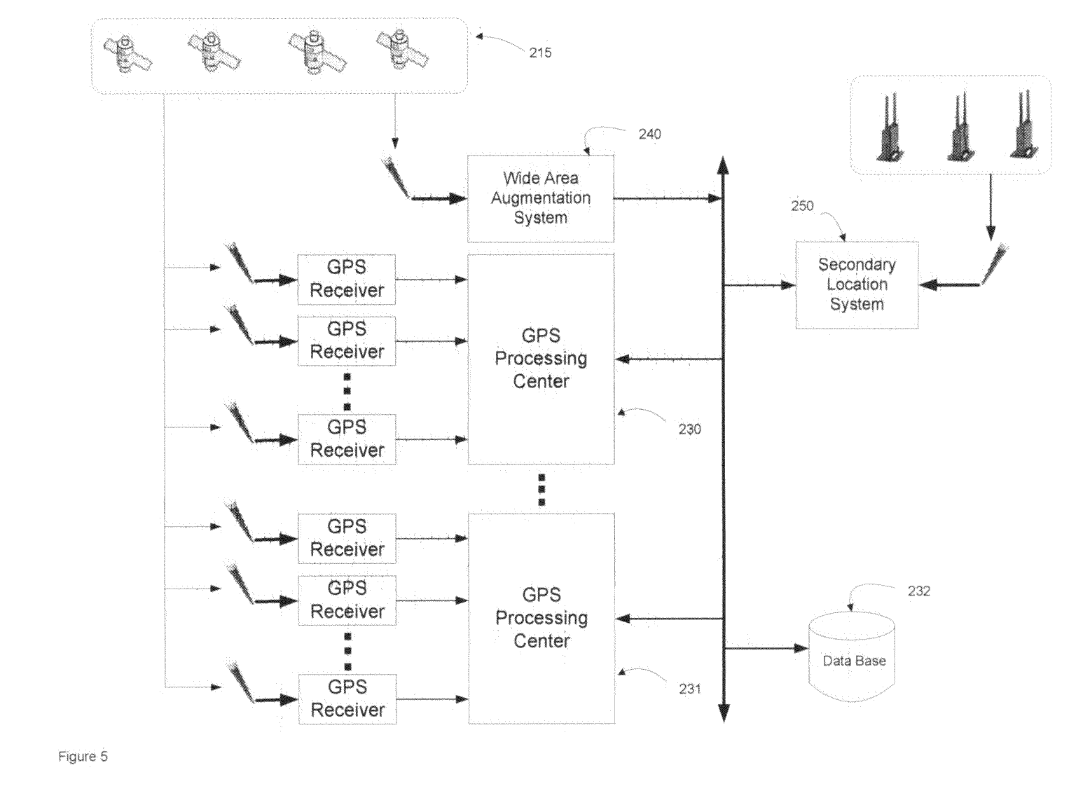

FIG. 5 shows a another non-limiting embodiment of the current invention illustrating a GPS processing facility, where a GPS processing facility can-be comprised of the following elements; a plurality of GPS processing centers 230, 231, an external wide area augmentation system (WAAS) 240, an auxiliary location technology 250, a GPS database 232. Furthermore, all of these elements are connected via a GPS communication bus 260. GPS communication bus 260 may be comprised of well known WAN and LAN technologies.

This allows for the processing of time and location datagrams from GPS receivers connected to distributed GPS processing centers 230, 231. A GPS database 232 can be employed to assist in the storage, search, and synchronization Of GPS receiver time and location datagrams.

An external wide area augmentation system (WAAS) 240, irk communication with the GPS processing facility can be used to improve accuracy of individual GPS receivers. An auxiliary location technology 250 is employed by the GPS processing facility to augment location coordinates obtained via the GPS system. This allows for improve location reliability and accuracy of individual GPS receivers. This is especially useful in cases where GPS receivers will be in service at locations where GPS signal levels are not present. Non-limiting examples of these types of technologies are wifi (802.11) based and television signal based location systems.

We claim:

1. A method of determining the location of a GPS receiver by means of a GPS processing facility incorporating a GPS signal processor, wherein:
one or more time and location datagrams extracted from received satellite signals are transferred from said GPS receiver to a GPS processing facility, where
said GPS signal processor removes the low frequency overlay data from the time and location datagram(s) to assist in the determination of the location of said GPS receiver.

2. The method of claim 1 where one or more of the time and location datagrams are transferred to the GPS processing facility via a wireless communications link.

3. The method of claim 1 where one or more of the time add location datagrams are transferred to the GPS processing facility via a wired communications link.

4. The method of claim 1 where one or more of the time and location datagrams may be recorded by the GPS receiver and transferred to GPS processing facility at later time.

5. The method of claim 1, wherein a database of time and location datagrams is maintained for reference by the GPS processing facility.

6. The method of claim 1, wherein a wide area augmentation system is employed by the GPS processing facility to improve the accuracy of the determined location of the GPS receiver.

7. The method of claim 1, wherein an auxiliary location system is used by the GPS processing facility in order to enhance the ability to obtain a location fix and improve the accuracy of the determined locations of the GPS receiver.

8. The method of claim 1, wherein the transfer of time and-location datagrams from a GPS receiver to a GPS processing facility may be performed in response to a request by said GPS processing facility.

9. A method of determining the location of one or more of an ensemble of multiple GPS receivers by means of a GPS processing facility incorporating a GPS signal processor, wherein:
time and location datagrams extracted from satellite signals are transferred from two or more of said ensemble of GPS receivers to a GPS processing facility, where
said GPS signal processor processes said time and location datagrams using signal combining in order to assist in the determination of the location(s) of the GPS receiver(s).

10. The method of claim 9 where one or more of the time and location datagrams are transferred to the GPS processing facility via a wireless communications link.

11. The method of claim 9 where one or more of the time and location datagrams are transferred to the GPS processing facility via a wired communications link.

12. The method of claim 9 where one or more of the time and location datagrams are recorded by the GPS receiver and transferred to GPS processing facility at later time

13. The method of claim 9, wherein a database of time and location datagrams is maintained for reference by the GPS processing facility

14. The method of claim 9, wherein a wide area augmentation system is employed by the GPS processing facility to improve the accuracy of the determined locations of GPS receivers

15. The method of claim 9, wherein an auxiliary location system is used by the GPS processing facility in order to enhance the ability to obtain a location fix and improve the accuracy of the determined locations of GPS receivers

16. The method of claim 9, wherein the transfer of time and location datagrams from a GPS receiver to a GPS processing facility may be performed in response to a request by said GPS processing facility.

17. The method of claim 9, wherein two or more time and location datagrams are time aligned by the GPS signal processor.

18. The method of claim 9, wherein time and location datagrams vary in length.

19. A method of determining the location of one or more of an ensemble of multiple GPS receivers by means of a GPS processing facility incorporating a GPS signal processor, wherein:
time and location datagrams extracted from satellite signals are transferred from two or more of said ensemble of GPS receivers to a GPS processing facility, where
said GPS signal processor removes the low frequency data overlay data from said time and location datagrams, and
said GPS signal processor processes said time and location datagrams using signal combining in order to assist in the determination of the location(s) of the GPS receiver(s).

20. The method of claim 19 where one or more of the time and location datagrams are transferred to the GPS processing facility via a wireless communications link

21. The method of claim 19 where one or more of the time and location datagrams are transferred to the GPS processing facility via a wired communications link

22. The method of claim 19 where one or more of the time and location datagrams are recorded by the GPS receiver and transferred to GPS processing facility at later time

23. The method of claim 19, wherein a database of time and location datagrams is maintained for reference by the GPS processing facility

24. The method of claim 19, wherein a wide area augmentation system is employed by the GPS processing facility to improve the accuracy of the determined locations of GPS receivers

25. The method of claim 19, wherein an auxiliary location system is used by the GPS processing facility in order to enhance the ability to obtain a location fix and improve the accuracy of the determined locations of GPS receivers

26. The method of claim 19, wherein the transfer of time and location datagrams from a GPS receiver to a GPS processing facility may be performed in response to a request by said GPS processing facility.

27. The method of claim 19, wherein two or more time and location datagrams are time aligned by the GPS signal processor.

28. The method of claim 19, wherein time and location datagrams vary in length.

29. An apparatus used in determining the location of one or more of an ensemble of multiple, GPS receivers wherein;
time and location datagrams extracted from satellite signals are received from two or more of said ensemble of GPS receivers, and
are processed to remove the low frequency overlay data, and
are processed using signal combining, in order to assist in the determination of the location(s) of the GPS receiver(s).
